(19) United States
(12) Patent Application Publication
(10) Pub. No.: US 2011/0131651 A1
(43) Pub. Date: Jun. 2, 2011

(54) METHOD AND DEVICE FOR DETECTING A SPOOFING ATTACK IN A WIRELESS COMMUNICATION NETWORK

(76) Inventors: Senthilraj Shanmugavadivel, Coimbatore (IN); Pranav Choudhary, Bangalore (IN); Vinodh Kumar, Chennai (IN)

(21) Appl. No.: 12/628,305

(22) Filed: Dec. 1, 2009

(51) Int. Cl. G06F 21/00

(52) U.S. Cl. 726/22

(57) ABSTRACT

A method and device enables detecting a spoofing attack in a wireless communication network (100). The method includes receiving at the primary access point (105) a beacon signal transmitted from an alternative access point (115), where the beacon signal includes an alternative access point identification. The primary access point (105) then compares the alternative access point identification with an actual identification of the primary access point (105). It is then determined at the primary access point that the alternative access point (115) is conducting a spoofing attack if the alternative access point identification matches the actual identification of the primary access point (105).

### FIELD OF THE DISCLOSURE

The present invention relates generally to wireless communication devices, and in particular to detecting at a wireless access point the existence of a rogue “evil twin” access point.

### BACKGROUND

A wireless access point (AP) is a device that enables a wireless communication node such a notebook computer or mobile telephone to connect to a network. Standards such as the Institute of Electrical and Electronics Engineers (IEEE) 802.11 family of standards, Bluetooth® standards, and wireless interoperability for microwave access (WiMax) standards are generally used to determine appropriate communication operating protocols between a wireless AP and a node. For example, many homes and businesses now include IEEE 802.11 wireless access points that function as a gateway to wired networks including the Internet.

Wireless APs are also now commonly used to define wireless “hot spots”. Such hot spots are physical locations that provide Internet access in a local area network (LAN) using a shared Internet connection established through one or more wireless APs. Hot spots are now common in many public spaces such as at airport terminals, hotels, libraries and coffee shops. To attract customers, many organizations allow connection to a wireless AP at a hot spot free of charge. Thus hot spot Internet access is often more desirable than alternative Internet access options such as subscription-based third generation (3G) wireless network options.

However, connecting to wireless access points at public hot spots can present security risks. A computer hacker at a hot spot can establish a rogue wireless access point, known as an “evil twin” access point, which masquerades as a legitimate hot spot access point. That is sometimes called a spoofing attack, as the evil twin access point attempts to spoof the legitimate access point. When a user unknowingly connects to such an evil twin access point, the computer hacker can eavesdrop on wireless communications sent from and received by the user. Such an evil twin attack can be used by the hacker for various nefarious purposes such as stealing user passwords.

A rogue, evil twin access point can be established for example on a notebook computer with some very simple program code and a wireless network card. Because such an evil twin access point can be established adjacent legitimate hot spot users, such as at a table in a coffee shop, a signal from the evil twin access point may be stronger than the signal from the legitimate hot spot access point. Hot spot users looking for the strongest network signal thus may be more likely to log on to the evil twin access point than to the legitimate access point. Further, evil twin access points can be difficult to trace because they can be set up and shut down very easily and quickly.

Because of the above described risks of evil twin access points, there is a need for an improved method and device for detecting a spoofing attack in a wireless communication network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram illustrating a wireless communication network that includes a primary access point, according to an embodiment of the present invention.

FIG. 2 is a flow diagram illustrating a method of determining at a primary access point in a wireless communication network whether an alternative access point is conducting a spoofing attack, according to an embodiment of the present invention.

FIG. 3 is a general flow diagram illustrating a method for determining at a primary access point in a wireless communication network whether an alternative access point is conducting a spoofing attack, according to an embodiment of the present invention.

FIG. 4 is a block diagram illustrating components of a primary access point, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, a method enables determining at a primary access point in a wireless communication network whether an alternative access point is conducting a spoofing attack. The method includes receiving at the primary access point a beacon signal transmitted from the alternative access point, where the beacon signal includes an alternative access point identification. The primary access point then compares the alternative access point identification with an actual identification of the primary access point. It is then determined at the primary access point that the alternative access point is conducting a spoofing attack if the alternative access point identification matches the actual identification of the primary access point.

Embodiments of the present invention thus enable a legitimate access point to detect the existence of an “evil twin” access point and provide an alert to network users. The security of local area network (LAN) hot spots thus can be significantly improved.

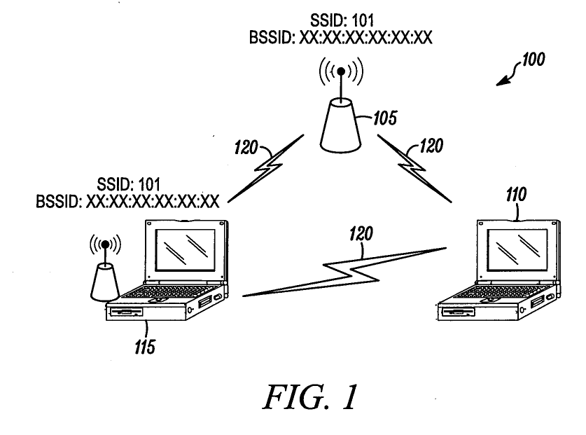

Referring to FIG. 1, a schematic diagram illustrates a wireless communication network 100 that includes a primary access point 105, according to an embodiment of the present invention. For example, the primary access point 105 may be owned and operated by a business, such as a coffee shop, that provides an Internet hot spot to customers. A customer thus may own a notebook computer 110 that seeks to wirelessly connect to the primary access point 105 as a gateway to the Internet. The business will therefore provide the customer with an identification of the primary access point 105, which identification is included in beacons broadcast from the primary access point 105. The customer will then perform a network scan on the notebook computer 110 and attempt to identify and log on to the primary access point 105.

However, if a computer hacker is operating another notebook computer as an “evil twin” alternative access point 115 in or near the business, the alternative access point 115 may also broadcast beacons that include the identification of the primary access point 105. In FIG. 1 the lightning icons 120 indicate wireless communications, including beacons, transmitted between the primary access point 105, the notebook computer 110, and the alternative access point 115. If the notebook computer 110 discovers a beacon sent from the alternative access point 115 before discovering a beacon sent from the primary access point 105, or if a signal strength indicated by a beacon sent from the alternative access point 115 is stronger than a signal strength indicated by a beacon sent from the primary access point 105, then the notebook computer 110 may log on to the alternative access point 115.

If the notebook computer 110 logs on to the alternative access point 115, then a computer hacker operating the alternative access point 115 could violate the security of the notebook computer 110 in various ways. For example, the alternative access point 115 could maintain a connection with the primary access point 105 and enable the notebook computer 110 to log on to the primary access point 105 through the alternative access point 115. However, the alternative access point 115 could then intercept, eavesdrop on and record all communications, including for example sensitive passwords, sent to and from the notebook computer 110. Such an arrangement is known by those having ordinary skill in the art as a man-in-the-middle (MITM) computer hacker attack.

The alternative access point 115 could also present false Internet web pages to the notebook computer 110 in an effort to fool the user of the notebook computer 110 into entering sensitive login, account and/or password information. That type of arrangement is known by those having ordinary skill in the art as a phishing attack.

However, according to an embodiment of the present invention, the primary access point 105 is able to promptly detect operation of the alternative access point 115 as an “evil twin”. An operator of the primary access point 105 is then able to either locate and shut down the alternative access point 115, or notify network users, such as a user of the notebook computer 110, of the existence of the alternative access point 115 so that such users can take defensive measures to ensure that they do not log on to the alternative access point 115.

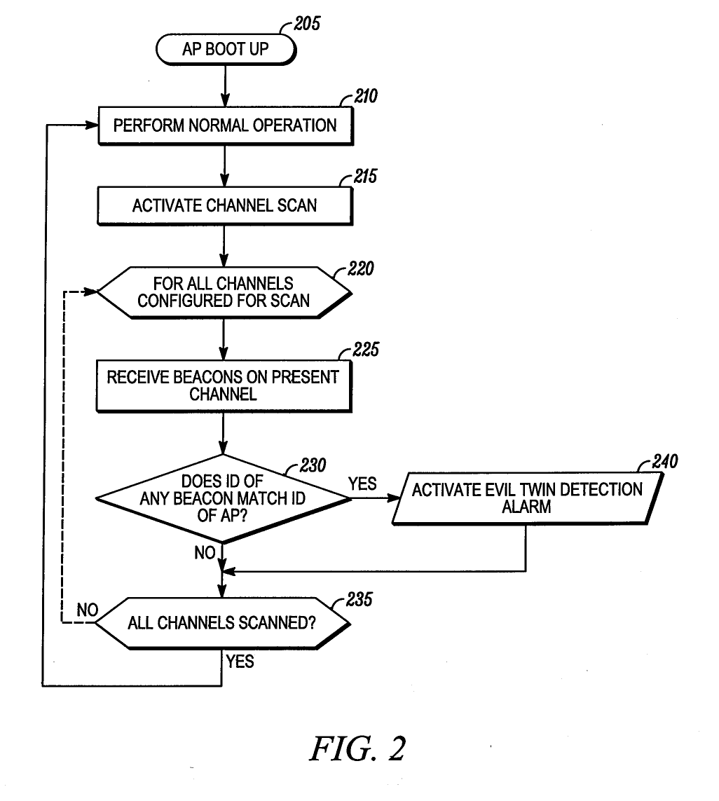

Referring to FIG. 2, a flow diagram illustrates a method 200 of determining at the primary access point 105 in the wireless communication network 100 whether the alternative access point 115 is conducting a spoofing attack, according to an embodiment of the present invention. At block 205, the primary access point 105 is booted up. At block 210, the primary access point 105 then performs its normal operation. After a predetermined period, at block 215 a channel scan process is activated. As described below, the channel scan process scans likely alternative channels on which an “evil twin” access point might be operating.

For example, the 2.4000-2.4835 Giga-Hertz (GHz) band of the IEEE 802.11 b/g/n standards is generally divided into 13 channels each having a width of 22 Mega-Hertz (MHz) and spaced 5 MHz apart. Each of these 13 channels can be sequentially scanned to determine whether a spoofing attack is presently being conducted in the wireless communication network 100.

At block 220, a first channel (e.g., channel 1) is selected from an appropriate channel set. At block 225, the primary access point 105 may receive a beacon signal, if any exist, currently being broadcast on the first channel. Next, at block 230, the primary access point 105 compares an identification included in the received beacon signal with an identification of the primary access point 105. For example, access point beacon signals in IEEE 802.11 networks often comprise a service set identifier (SSID) that is generally a human readable word but can be any sequence of 1-32 octets of any value. Alternatively, an identification may comprise a basic service set identifier (BSSID), which is generally a locally administered medium access control (MAC) address generated from a 46 bit random number.

If an identification included in the received beacon signal does not match an identification of the primary access point 105, then the method 200 continues to block 235 where it is determined whether all appropriate channels have been scanned. However, if at block 230 it is determined that an identification of the primary access point 105 does match an identification included in the present beacon, such as a beacon received from the alternative access point 115, then at block 240 an alarm is activated that indicates that an “evil twin” spoofing attack is presently being conducted. Operators of the primary access point 105 are then able to take defensive measures such as, for example, alerting all users of the wireless communication network 100 that a spoofing attack is in progress, or searching for and shutting down the rogue alternative access point 115. The method 200 then continues to block 235.

If at block 235 it is determined that all appropriate channels have not been scanned, then the method 200 returns to block 220 where a relevant channel number is incremented and the primary access point 105 listens for beacons on a new channel. If however all appropriate channels have been scanned, then the method 200 returns to block 210. The primary access point 105 then performs its normal operations until a timer again triggers activation of a channel scan at block 215. Depending on perceived security risks, such a timer can be set by an operator of the primary access point 105 to trigger at appropriate intervals, such as every five minutes.

As will be understood by those having ordinary skill in the art, the above described method 200 concerns an “off channel” scan. Alternatives of the method 200 may include a process that scans only a dedicated channel (i.e., an “on channel” scan) on which the primary access point 105 is operating. Further, according to still another embodiment of the present invention, the primary access point 105 may receive beacon signals while a channel scanning mode of the primary access point 105 is disabled. Identifications included in the received beacon signals are then subsequently compared with an identification of the primary access point 105.

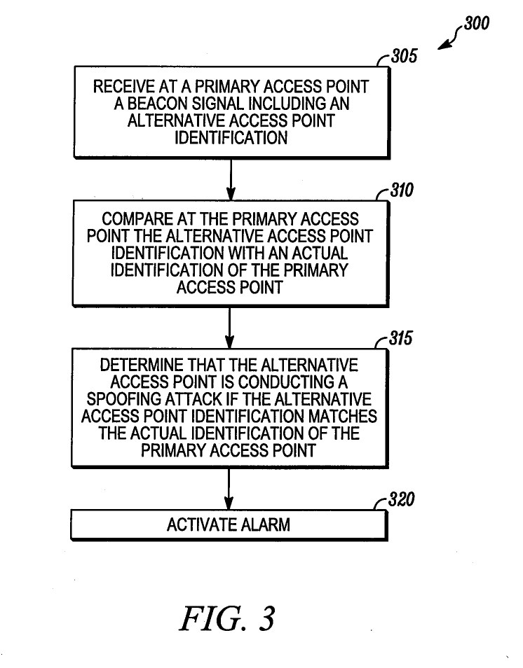

Referring to FIG. 3, a general flow diagram illustrates a method 300 for determining at a primary access point in a wireless communication network whether an alternative access point is conducting a spoofing attack, according to an embodiment of the present invention. At block 305, a beacon signal transmitted from the alternative access point is received at the primary access point, wherein the beacon signal includes an alternative access point identification. For example, a beacon signal transmitted from the alternative access point 115 is received at the primary access point 105, and includes a BSSID of the primary access point 105.

At block 310, the primary access point compares the alternative access point identification with an actual identification of the primary access point. Next, at block 315, it is determined at the primary access point that the alternative access point is conducting a spoofing attack if the alternative access point identification matches the actual identification of the primary access point. For example, if the alternative access point identification included in the beacon signal received from the alternative access point 115 matches the BSSID of the primary access point 105, then it can be determined that the alternative access point 115 is conducting an “evil twin” attack against the primary access point 105.

At block 320, an alarm is activated after determining that the alternative access point is conducting a spoofing attack. For example, an alarm may include transmitting an alert message to all users of the wireless communication network 100, or transmitting a text message to an operator of the primary access point 105.

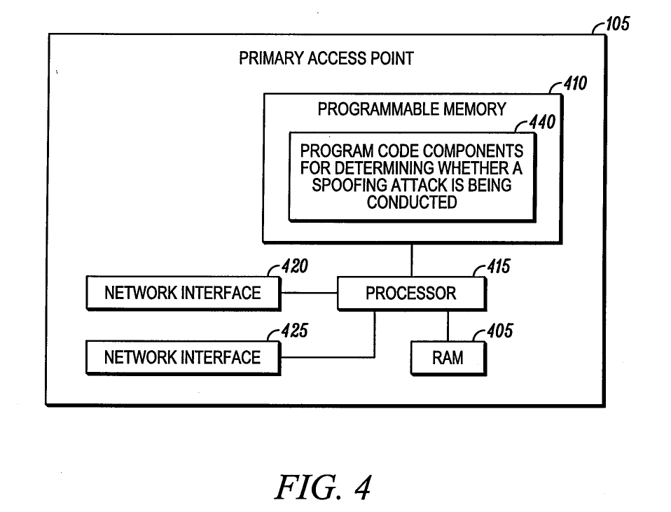

Referring to FIG. 4, a block diagram illustrates components of the primary access point 105, according to an embodiment of the present invention. The primary access point 105, for example, can comprise at least all the elements depicted in FIG. 4, as well as any other elements necessary for the primary access point 105 to perform its particular functions. Alternatively, the primary access point 105 can comprise a collection of appropriately interconnected units or devices, wherein such units or devices perform functions that are equivalent to the functions performed by the elements depicted in FIG. 4.

The primary access point 105 comprises a random access memory (RAM) 405 and a programmable memory 410 that are coupled to a processor 415. The processor 415 also has ports for coupling to network interfaces 420, 425. The network interfaces 420, 425 can be used to enable the primary access point 105 to communicate with other devices in the wireless communication network 100 and with a wired backbone link to the Internet. For example the network interface 420 may be used to communicate with the notebook computer 110.

The programmable memory 410 can store operating code (OC) for the processor 415 and code for performing functions associated with an access point. For example, the programmable memory 410 can store computer readable program code components 440 configured to cause execution of a method, such as the method 300, for determining at a primary access point in a wireless communication network whether an alternative access point is conducting a spoofing attack, as described herein.

Wireless portable electronic devices, such as the primary access point 105, that utilize and benefit from embodiments of the present invention can utilize various types of wireless network architectures including a mesh enabled architecture (MEA) network, an Institute of Electrical and Electronics Engineers (IEEE) 802.11 network (e.g., 802.11a, 802.11b, 802.11g, 802.11n), or a worldwide interoperability for microwave access (WiMax) network. It will be appreciated by those of ordinary skill in the art that such wireless communication networks can alternatively comprise any packetized communication network where packets are forwarded across multiple wireless hops. For example, such a wireless communication network can be a network utilizing multiple access schemes such as OFDMA (orthogonal frequency division multiple access), TDMA (time division multiple access), FDMA (Frequency Division Multiple Access), or CSMA (Carrier Sense Multiple Access).

Advantages of some embodiments of the present invention therefore include enabling a legitimate access point to detect the existence of an “evil twin” access point and provide an alert to network users. The security of local area network (LAN) hot spots thus can be significantly improved.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element preceded by “comprises a . . . ”, “has a . . . ”, “includes a . . . ”, or “contains a . . . ” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for determining at a primary access point in a wireless communication network whether an alternative access point is conducting a spoofing attack, the method comprising:
receiving at the primary access point a beacon signal transmitted from the alternative access point, wherein the beacon signal includes an alternative access point identification;
comparing at the primary access point the alternative access point identification with an actual identification of the primary access point; and
determining at the primary access point that the alternative access point is conducting a spoofing attack if the alternative access point identification matches the actual identification of the primary access point.

2. The method of claim 1, further comprising activating an alarm after determining that the alternative access point is conducting a spoofing attack.

3. The method of claim 1, wherein the primary access point receives the beacon signal while performing an on channel scan.

4. The method of claim 1, wherein the primary access point receives the beacon signal while performing an off channel scan.

5. The method of claim 1, wherein the primary access point receives the beacon signal while a channel scanning mode of the primary access point is disabled.

6. The method of claim 1, wherein the alternative access point identification is a service set identifier (SSID).

7. The method of claim 1, wherein the alternative access point identification is a basic service set identifier (BSSID).

8. The method of claim 1, wherein the alternative access point is operating as an evil twin access point.

9. The method of claim 1, wherein the wireless communication network is an Institute of Electrical and Electronics Engineers (IEEE) 802.11 network.

10. A primary access point, comprising:
a processor; and
a memory operatively coupled to the processor, wherein the memory comprises:
computer readable program code components for receiving at the primary access point a beacon signal transmitted from an alternative access point, wherein the beacon signal includes an alternative access point identification;
computer readable program code components for comparing at the primary access point the alternative access point identification with an actual identification of the primary access point; and
computer readable program code components for determining at the primary access point that the alternative access point is conducting a spoofing attack if the alternative access point identification matches the actual identification of the primary access point.

11. The primary access point of claim 10, further comprising activating an alarm after determining that the alternative access point is conducting a spoofing attack.

12. The primary access point of claim 10, wherein the primary access point receives the beacon signal while performing an on channel scan.

13. The primary access point of claim 10, wherein the primary access point receives the beacon signal while performing an off channel scan.

14. The primary access point of claim 10, wherein the primary access point receives the beacon signal while a channel scanning mode of the primary access point is disabled.

15. The primary access point of claim 10, wherein the alternative access point identification is a service set identifier (SSID).

16. The primary access point of claim 10, wherein the alternative access point identification is a basic service set identifier (BSSID).

17. The primary access point of claim 10, wherein the alternative access point is operating as an evil twin access point.

18. The primary access point of claim 10, wherein the wireless communication network is an Institute of Electrical and Electronics Engineers (IEEE) 802.11 network.

19. A primary access point, comprising:
means for receiving at the primary access point a beacon signal transmitted from an alternative access point, wherein the beacon signal includes an alternative access point identification;
means for comparing at the primary access point the alternative access point identification with an actual identification of the primary access point; and
means for determining at the primary access point that the alternative access point is conducting a spoofing attack if the alternative access point identification matches the actual identification of the primary access point.
